(19) United States
(12) Patent Application Publication
(10) Pub. No.: US 2026/0331583 A1
(43) Pub. Date: Oct. 22, 2026

(54) ELECTROCHEMICAL APPARATUS AND ELECTRONIC APPARATUS

(71) Applicant: Ningde Amperex Technology Limited, Ningde (CN)

(72) Inventors: Zhiyi GAO, Ningde (CN); Chao TANG, Ningde (CN)

(73) Assignee: Ningde Amperex Technology Limited, Ningde (CN)

(21) Appl. No.: 19/536,284

(22) Filed: Feb. 11, 2026

(30) Foreign Application Priority Data
Feb. 12, 2025 (CN) 202510155515.7

(51) Int. Cl. H01M 10/0567; H01M 4/02; H01M 4/583

(52) U.S. Cl. CPC H01M 10/0567; H01M 4/583; H01M 2004/021; H01M 2004/027

(57) ABSTRACT

An electrochemical apparatus includes a positive electrode, a negative electrode, and an electrolyte. The negative electrode includes a negative electrode current collector and a negative electrode active material layer located on at least a part of a surface of the negative electrode current collector. An areal density of the negative electrode active material layer is cw mg/mm², where 8.44≤cw≤10.38. Based on a mass of the electrolyte, the electrolyte includes: ethylene carbonate with a mass percentage of A %, propylene carbonate with a mass percentage of B %, diethyl carbonate with a mass percentage of C %, ethyl propionate with a mass percentage of D %, and propyl propionate with a mass percentage of E %; where 1≤A/B≤3, and 2≤(E+D)/C≤8.

### CROSS-REFERENCE TO RELATED APPLICATION

This application claims the benefit of priority from the Chinese Patent Application No. 202510155515.7, filed on Feb. 12, 2025, the entire content of which is incorporated herein by reference.

### TECHNICAL FIELD

This application pertains to the field of energy storage technology and specifically relates to an electrochemical apparatus and an electronic apparatus.

### BACKGROUND

Secondary batteries, as rechargeable energy storage apparatuses, achieve mutual conversion between electrical energy and chemical energy through chemical reactions during charging and discharging. Currently, secondary batteries, with their high energy density, long cycle life, and environmental friendliness, are widely used in fields such as mobile communication, electric vehicles, and energy storage systems.

However, during long-term cycling, the secondary battery may face the problem that the space for other components in the device is occupied due to increased thickness of a negative electrode material. As an important component in the battery, the stability of a negative electrode directly affects the overall performance and cycle life of the battery. During charge-discharge cycles, the negative electrode material undergoes intercalation and deintercalation of lithium ions. This process is often accompanied by volume changes in the material and destruction and repair of an interfacial SEI film, leading to gradual increase in the thickness of the negative electrode. The increase in the thickness of the negative electrode not only reduces the energy density of the battery but may also cause concentration of internal stress in the battery, leading to destruction of the electrode structure and rapid capacity decay of the battery. Therefore, to improve the comprehensive performance of the secondary battery, how to mitigate the increase in the thickness of the negative electrode has become an urgent problem to be solved.

### SUMMARY

In view of this, this application provides an electrochemical apparatus and an electronic apparatus. By optimizing components of an electrolyte, side reactions between a negative electrode material and the electrolyte can be reduced, the thickness growth of a negative electrode during cycling can be alleviated, and the gas production under float charging conditions can also be reduced, thereby solving the above problems.

According to a first aspect, this application provides an electrochemical apparatus including a positive electrode, a negative electrode, and an electrolyte, where the negative electrode includes a negative electrode current collector and a negative electrode active material layer located on at least a part of a surface of the negative electrode current collector; an areal density of the negative electrode active material layer is cw mg/mm², where 8.44≤cw≤10.38; and based on a mass of the electrolyte, the electrolyte includes: ethylene carbonate with a mass percentage of A %, propylene carbonate with a mass percentage of B %, diethyl carbonate with a mass percentage of C %, ethyl propionate with a mass percentage of D %, and propyl propionate with a mass percentage of E %; where 1≤A/B≤3, and 2≤(E+D)/C≤8. The inventors have found that: by using ethylene carbonate in combination with propylene carbonate in the electrolyte and controlling their mass percentages to satisfy the above relationship, a higher percentage of ethylene carbonate can facilitate the formation of a high-quality solid electrolyte interphase (SEI) film at a negative electrode interface, thereby reducing or suppressing side reactions between the negative electrode interface and the electrolyte, and helping to alleviate the thickness growth of the negative electrode during cycling. The two carboxylic esters, ethyl propionate and propyl propionate, can improve the permeability of the electrolyte, reduce uneven phenomena, and further decrease the occurrence of side reactions. After interaction between propylene carbonate and diethyl carbonate, an electrochemical stability window of the electrolyte can be broadened. When the mass percentages of the carboxylic esters and diethyl carbonate are controlled to satisfy the above relationship, the components closely cooperate to suppress oxidative gas production from ethylene carbonate and the carboxylic esters, alleviating the float charging gas production performance of the electrochemical apparatus.

In some embodiments, the electrolyte satisfies at least one of the following conditions: (1) 15≤A≤30; (2) 10≤B≤15; (3) 10≤C≤15; (4) 30≤D≤40; (5) 10≤E≤35; (6) 1.5≤A/B≤2; or (7) 4≤(E+D)/C≤5. When the mass percentages of the components in the electrolyte are adjusted to satisfy the above ranges, the close cooperation of the components can be facilitated, further alleviating the float charging gas production performance and electrode thickness growth rate of the electrochemical apparatus.

In some embodiments, the electrolyte includes succinonitrile, adiponitrile, and 1,3,6-hexanetricarbonitrile; and based on the mass of the electrolyte, a mass percentage of succinonitrile is F %, a mass percentage of adiponitrile is G %, and a mass percentage of 1,3,6-hexanetricarbonitrile is H %, where 2≤H≤3, and 1≤G/(F+H)≤1.3. In this application, succinonitrile, adiponitrile, and 1,3,6-hexanetricarbonitrile are simultaneously added to the electrolyte, which can complex with transition metal sites exposed at a positive electrode interface, reducing oxidative decomposition of the electrolyte by the positive electrode under full charge conditions during float charging, and alleviating the float charging gas production performance. In particular, when the mass percentages of the three in the electrolyte are adjusted to satisfy the above ranges, the float charging gas production performance of the electrochemical apparatus can be further alleviated.

In some embodiments, 1≤F≤3. Adjusting the mass percentage of succinonitrile in the electrolyte to satisfy this range can further alleviate the float charging gas production performance of the electrochemical apparatus.

In some embodiments, the electrolyte includes fluoroethylene carbonate or 1,3-propane sultone; and based on the mass of the electrolyte, a mass percentage of fluoroethylene carbonate is U %, and a mass percentage of 1,3-propane sultone is V %, where 4≤U≤9.55, and 2≤V≤6. In this application, fluoroethylene carbonate (FEC) is added to the electrolyte, which can form a LiF-rich interface at the negative electrode interface; and in combination with a high percentage of ethylene carbonate, fluoroethylene carbonate can suppress side reactions on the negative electrode surface, inhibit the electrode thickness growth rate during cycling, and alleviate the float charging gas production performance of the electrochemical apparatus. In this application, 1,3-propane sultone (1,3-PS) is added to the electrolyte, which can improve the film-forming quality at the negative electrode interface, enhance interfacial protection on a negative electrode side, inhibit the electrode thickness growth rate during cycling, and alleviate the float charging gas production performance of the electrochemical apparatus.

In some more preferred embodiments, 6≤U≤8; or 3≤V≤4. Controlling the mass percentage of FEC or 1,3-PS in the electrolyte to the preferred range can further alleviate the float charging gas production performance and electrode thickness growth rate during cycling of the electrochemical apparatus.

In some embodiments, the electrolyte includes lithium hexafluorophosphate and a second lithium salt, the second lithium salt including lithium tetrafluoroborate or lithium difluoro(oxalato)borate; and based on the mass of the electrolyte, a mass percentage of the second lithium salt is P %, where 0.1≤P≤0.8, preferably 0.2≤P≤0.4. Adding the second lithium salt to the electrolyte in combination with lithium hexafluorophosphate can enhance protection on the interfaces of the positive electrode and/or negative electrode and reduce side reactions at the interfaces, thereby further alleviating the float charging gas production performance and electrode thickness growth rate during cycling of the electrochemical apparatus.

In some embodiments, the electrolyte satisfies at least one of the following conditions: (1) the electrolyte includes tetrakis(trimethylsiloxy) titanium, and based on the mass of the electrolyte, a mass percentage of tetrakis(trimethylsiloxy) titanium is X %, where 1≤X≤2; (2) the electrolyte includes tris(4-morpholinyl)phosphine oxide, and based on the mass of the electrolyte, a mass percentage of tris(4-morpholinyl)phosphine oxide is Y %, where 0.3≤Y≤0.5; or (3) the electrolyte includes diethyl phenylphosphonate, and based on the mass of the electrolyte, a mass percentage of diethyl phenylphosphonate is Z %, where 0.3≤Z≤0.5.

Based on the above electrolyte scheme, interaction among the components in the electrolyte can further alleviate the float charging gas production performance and electrode thickness growth rate during cycling of the electrochemical apparatus.

In some specific embodiments, the negative electrode active material layer includes graphite, the graphite including natural graphite and/or artificial graphite, where an average particle size of the graphite is 7 μm to 14 μm. The average particle size of the graphite is within this range, so that after the graphite closely cooperates with the components of the electrolyte in this application, the film-forming quality of the SEI film can be improved, further alleviating the float charging gas production performance and electrode thickness growth rate during cycling of the electrochemical apparatus.

In some embodiments, a compacted density of the negative electrode active material layer is pd g/mm², where 1.6≤pd≤1.8. When the compacted density of the negative electrode active material layer is adjusted to satisfy the above range, the compacted density cooperates with the above areal density characteristics, so that the float charging gas production performance and electrode thickness growth rate during cycling of the electrochemical apparatus can be better alleviated.

According to a second aspect, this application provides an electronic apparatus including the electrochemical apparatus according to any one of the foregoing embodiments.

### DETAILED DESCRIPTION

To make the objectives, technical solutions, and advantages of this application clearer, the following further describes this application in detail with reference to some embodiments. It should be understood that the specific embodiments described herein are only used to explain this application and are not intended to limit this application.

According to a first aspect, this application provides an electrochemical apparatus including a positive electrode, a negative electrode, and an electrolyte, where the negative electrode includes a negative electrode current collector and a negative electrode active material layer located on at least a part of a surface of the negative electrode current collector; an areal density of the negative electrode active material layer is cw mg/mm², where 8.44≤cw≤10.38; and based on a mass of the electrolyte, the electrolyte includes: ethylene carbonate with a mass percentage of A %, propylene carbonate with a mass percentage of B %, diethyl carbonate with a mass percentage of C %, ethyl propionate with a mass percentage of D %, and propyl propionate with a mass percentage of E %; where 1≤A/B≤3, and 2≤(E+D)/C≤8. The inventors have found that: when the areal density of the negative electrode active material layer is relatively high, there is a large amount of active material per unit area of the negative electrode, leading to increased side reactions with the electrolyte, which easily causes thickness increase of a negative electrode plate during cycling; especially under float charging conditions, an increased contact area between a large amount of negative electrode active material and the electrolyte causes reactions and generates more gas. Accumulation of gas increases the internal pressure of the electrochemical apparatus, affecting the charge-discharge performance and safety performance. To solve this problem, this application proposes using ethylene carbonate in combination with propylene carbonate in the electrolyte and controlling their mass percentages to satisfy the above relationship. A high percentage of ethylene carbonate can alleviate the formation of a high-quality solid electrolyte interphase (SEI) film at a negative electrode interface, thereby reducing or suppressing side reactions between the negative electrode interface and the electrolyte, and helping to alleviate the thickness growth of the negative electrode during cycling. The two carboxylic esters, ethyl propionate and propyl propionate, can improve the permeability of the electrolyte, reduce uneven distribution of the electrolyte, and avoid exacerbation of local reactions. After interaction between propylene carbonate and diethyl carbonate, an electrochemical stability window of the electrolyte can be broadened, further reducing the occurrence of side reactions. When the mass percentages of the carboxylic esters and diethyl carbonate are controlled to satisfy the above relationship, the components closely cooperate to suppress oxidative gas production from ethylene carbonate and the carboxylic esters, alleviating the float charging gas production performance of the electrochemical apparatus.

In some embodiments, 1≤A/B≤3, preferably 1.5≤A/B≤2. Exemplarily, the value of A/B may be 1, 1.2, 1.6, 1.8, 1.9, 2.3, 2.5, 2.7, 2.9, 3, or a value within a range defined by any two of these values. When the mass percentages of ethylene carbonate and propylene carbonate are adjusted to satisfy the above relationship, better cooperation between the two can be facilitated, optimizing the film-forming quality of the SEI film and reducing the occurrence of side reactions in the electrolyte, thereby further alleviating the float charging gas production performance and electrode thickness growth rate during cycling of the electrochemical apparatus.

In some embodiments, 2≤(E+D)/C≤8, preferably 4≤(E+D)/C≤5. Exemplarily, the value of (E+D)/C may be 2, 2.7, 3.6, 4.2, 5.2, 5.5, 6.3, 7.3, 7.8, 8, or a value within a range defined by any two of these values. When the mass percentages of diethyl carbonate, ethyl propionate, and propyl propionate are adjusted to satisfy the above range, side reactions between the electrolyte and the negative electrode as well as oxidative gas production from the carboxylic esters can be further reduced, resulting in lower float charging gas production and electrode thickness growth rate during cycling of the electrochemical apparatus.

In some embodiments, 15≤A≤30. For example, A may be 15, 17, 19, 21, 22, 24, 26, 27, 29, 30, or a value within a range defined by any two of these values. Adjusting the mass percentage of ethylene carbonate in the electrolyte to satisfy the above range can improve the film-forming quality of the SEI film, further alleviating the float charging gas production performance and electrode thickness growth rate during cycling of the electrochemical apparatus.

In some embodiments, 10≤B≤15. For example, B may be 10, 11, 12, 13, 14, 15, or a value within a range defined by any two of these values. Adjusting the mass percentage of propylene carbonate to satisfy the above range, in combination with ethylene carbonate, can reduce the occurrence of side reactions, thereby further alleviating the float charging gas production performance and electrode thickness growth rate during cycling of the electrochemical apparatus.

In some embodiments, 10≤C≤15. Exemplarily, C may be 10, 11, 12, 13, 14, 15, or a value within a range defined by any two of these values. Using diethyl carbonate with the above mass percentage in the electrolyte can reduce the occurrence of side reactions and reduce oxidative gas production from the electrolyte, thereby better alleviating the float charging gas production performance and electrode thickness growth rate during cycling of the electrochemical apparatus.

In some embodiments, 30≤D≤40. Exemplarily, D may be 30, 31, 33, 34, 35, 36, 37, 39, 40, or a value within a range defined by any two of these values. Adjusting the mass percentage of ethyl propionate in the electrolyte to satisfy the above range, in combination with propyl propionate, can further reduce the occurrence of side reactions, alleviating the float charging gas production performance and electrode thickness growth rate during cycling of the electrochemical apparatus.

In some embodiments, 10≤E≤35. Exemplarily, E may be 10, 11, 13, 16, 20, 23, 24, 28, 31, 33, 35, or a value within a range defined by any two of these values. When the mass percentage of propyl propionate in the electrolyte is adjusted to satisfy the above range, close cooperation between propyl propionate and other components can be facilitated, further alleviating the float charging gas production performance and electrode thickness growth rate of the electrochemical apparatus.

In some embodiments, the electrolyte includes succinonitrile, adiponitrile, and 1,3,6-hexanetricarbonitrile; and based on the mass of the electrolyte, a mass percentage of succinonitrile is F %, a mass percentage of adiponitrile is G %, and a mass percentage of 1,3,6-hexanetricarbonitrile is H %, where 2≤H≤3, and 1≤G/(F+H)≤1.3. Exemplarily, H may be 2, 2.2, 2.3, 2.4, 2.6, 2.7, 2.8, 2.9, 3, or a value within a range defined by any two of these values. The value of G/(F+H) may be 1, 1.02, 1.05, 1.08, 1.13, 1.14, 1.17, 1.21, 1.26, 1.28, 1.3, or a value within a range defined by any two of these values. In this application, succinonitrile, adiponitrile, and 1,3,6-hexanetricarbonitrile are simultaneously added to the electrolyte, which can complex with transition metal sites exposed at a positive electrode interface, reducing oxidative decomposition of the electrolyte by the positive electrode under full charge conditions during float charging, and alleviating the float charging gas production performance. In particular, when the mass percentages of the three in the electrolyte are adjusted to satisfy the above ranges, the float charging gas production performance of the electrochemical apparatus can be further alleviated.

In some embodiments, 1≤F≤3. For example, the mass percentage of succinonitrile may be 1, 1.2, 1.4, 1.5, 1.7, 1.9, 2.3, 2.4, 2.6, 2.9, 3, or a value within a range defined by any two of these values. Adjusting the mass percentage of succinonitrile in the electrolyte to satisfy this range can further alleviate the float charging gas production performance of the electrochemical apparatus.

In some embodiments, 3≤G≤7.8. For example, G may be 3, 3.4, 3.6, 4.1, 4.7, 5.5, 5.7, 6.5, 6.9, 7.6, 7.8, or a value within a range defined by any two of these values. Adjusting the mass percentage of adiponitrile to satisfy the above range helps to further alleviate the float charging gas production performance of the electrochemical apparatus.

In some embodiments, the electrolyte includes fluoroethylene carbonate; and based on the mass of the electrolyte, a mass percentage of fluoroethylene carbonate is U %, where 4≤U≤9.55. For example, 6≤U≤8. Exemplarily, U may be 4, 6, 7, 8, 9, 9.55, or a value within a range defined by any two of these values. In this application, fluoroethylene carbonate (FEC) is added to the electrolyte, which can form a LiF-rich interface at the negative electrode interface; and in combination with a high percentage of ethylene carbonate, fluoroethylene carbonate can suppress side reactions on the negative electrode surface, inhibit the electrode thickness growth rate during cycling, and alleviate the float charging gas production performance of the electrochemical apparatus. When the mass percentage of fluoroethylene carbonate is adjusted to satisfy the above range, the film-forming quality of the negative electrode interface film can be further improved, alleviating the float charging gas production performance and electrode thickness growth rate during cycling of the electrochemical apparatus.

In some embodiments, the electrolyte includes 1,3-propane sultone; and based on the mass of the electrolyte, a mass percentage of 1,3-propane sultone is V %, where 2≤V≤6, preferably 3≤V≤4. Exemplarily, V may be 2, 3, 4, 5, 6, or a value within a range defined by any two of these values. In this application, 1,3-propane sultone (1,3-PS) is added to the electrolyte, which can improve the film-forming quality at the negative electrode interface, enhance interfacial protection on a negative electrode side, inhibit the electrode thickness growth rate during cycling, and alleviate the float charging gas production performance of the electrochemical apparatus. When the mass percentage of 1,3-propane sultone is adjusted to satisfy the above relationship, the float charging gas production performance and electrode thickness growth rate during cycling of the electrochemical apparatus can be further alleviated.

In some embodiments, the electrolyte includes lithium hexafluorophosphate and a second lithium salt, the second lithium salt including lithium tetrafluoroborate or lithium difluoro(oxalato)borate; and based on the mass of the electrolyte, a mass percentage of the second lithium salt is P %, where 0.1≤P≤0.8, preferably 0.2≤P≤0.4. Adding the second lithium salt to the electrolyte in combination with lithium hexafluorophosphate can enhance protection on the interfaces of the positive electrode and/or negative electrode and reduce side reactions at the interfaces, thereby further alleviating the float charging gas production performance and electrode thickness growth rate during cycling of the electrochemical apparatus. Lithium tetrafluoroborate can absorb residual hydrogen fluoride (HF) in the electrolyte, reducing corrosion of a positive electrode material by acidic substances while participating in interface film formation on a positive electrode side, reducing oxidative decomposition of the electrolyte. Lithium difluoro(oxalato)borate [LiBF₂(C₂O₄) or LiDFOB] can simultaneously oxidatively decompose and form films on both the positive electrode and negative electrode, and the formed film substances can inhibit irreversible side reactions of the electrolyte at the interfaces, protecting the structural stability of the electrodes. Exemplarily, the value of P may be 0.1, 0.2, 0.3, 0.4, 0.5, 0.6, 0.7, 0.8, or a value within a range defined by any two of these values. When the mass percentage of the second lithium salt is adjusted to satisfy the above range, the float charging gas production performance and electrode thickness growth rate during cycling of the electrochemical apparatus can be further alleviated.

In some embodiments, the electrolyte includes tetrakis(trimethylsiloxy) titanium; and based on the mass of the electrolyte, a mass percentage of tetrakis(trimethylsiloxy) titanium is X %, where 1≤X≤2. For example, X may be 1, 1.1, 1.3, 1.5, 1.6, 1.7, 1.8, 2, or a value within a range defined by any two of these values. In this application, tetrakis(trimethylsiloxy) titanium is added to the electrolyte, which can participate in film formation at the negative electrode, enhance protection on the negative electrode side to alleviate the thickness growth rate of the electrode plate, and also absorb HF and PF₅ generated from decomposition of the lithium salt in the electrolyte, protect the positive electrode structure, reduce side reactions inside the electrochemical apparatus, and alleviate float charging gas production.

In some embodiments, the electrolyte includes tris(4-morpholinyl)phosphine oxide; and based on the mass of the electrolyte, a mass percentage of tris(4-morpholinyl)phosphine oxide is Y %, where 0.3≤Y≤0.5. For example, Y may be 0.3, 0.32, 0.34, 0.35, 0.38, 0.41, 0.43, 0.45, 0.47, 0.5, or a value within a range defined by any two of these values. In this application, tris(4-morpholinyl)phosphine oxide is added to the electrolyte and can be specifically complexed and adsorbed at the positive electrode interface, improving positive electrode stability. When the mass percentage of tris(4-morpholinyl)phosphine oxide in the electrolyte is adjusted to satisfy the above range, the float charging gas production performance of the electrochemical apparatus can be further alleviated.

In some embodiments, the electrolyte includes diethyl phenylphosphonate; and based on the mass of the electrolyte, a mass percentage of diethyl phenylphosphonate is Z %, where 0.3≤Z≤0.5. For example, Z may be 0.3, 0.32, 0.34, 0.35, 0.38, 0.41, 0.43, 0.45, 0.47, 0.5, or a value within a range defined by any two of these values. In this application, diethyl phenylphosphonate is added to the electrolyte. When the mass percentage of diethyl phenylphosphonate is adjusted to satisfy the above range, diethyl phenylphosphonate can be specifically complexed and adsorbed at the positive electrode interface, alleviating the float charging gas production performance of the electrochemical apparatus.

According to some embodiments of this application, the electrolyte further includes another lithium salt and a non-aqueous solvent. The other lithium salt may include but is not limited to at least one of lithium bis(trifluoromethanesulfonyl)imide LiN(CF₃SO₂)₂ (LiTFSI), lithium bis(fluorosulfonyl)imide Li(N(SO₂F)₂) (LiFSI), lithium bis(oxalato)borate LiB(C₂O₄)₂ (LiBOB), LiNO₃, LiClO₄, LiB(C₆H₅)₄, LiCH₃SO₃, LiCF₃SO₃, LiC(SO₂CF₃)₃, or Li₂SiF₆. This application imposes no limitation on the percentage of the lithium salt in the electrolyte, provided that the objectives of this application can be achieved. This application imposes no particular limitation on the non-aqueous solvent, provided that the objectives of this application can be achieved. For example, the non-aqueous solvent may include but is not limited to at least one of an ether compound or another organic solvent. The above ether compound may include but is not limited to at least one of 1,3-dioxolane (DOL), ethylene glycol dimethyl ether (1,2-dimethoxyethane, DME), dibutyl ether, tetraethylene glycol dimethyl ether, diethylene glycol dimethyl ether, 1,2-diethoxyethane, 1-ethoxy-1-methoxyethane, 2-methyltetrahydrofuran, or tetrahydrofuran. The above another organic solvent may include but is not limited to at least one of dimethyl sulfoxide, 1,2-dioxolane, sulfolane, methyl sulfolane, 1,3-dimethyl-2-imidazolidinone, N-methyl-2-pyrrolidone, dimethylformamide, acetonitrile, trimethyl phosphate, triethyl phosphate, or trioctyl phosphate.

In some embodiments, the areal density of the negative electrode active material layer is cw mg/mm², where 8.44≤cw≤10.38. For example, the value of cw may be 8.44, 8.58, 8.85, 8.99, 9.27, 9.44, 9.53, 9.91, 10.05, 10.29, 10.38, or a value within a range defined by any two of these values. Adjusting the areal density of the negative electrode active material layer to satisfy the above range, in cooperation with the electrolyte system of this application, can increase a charge-discharge capacity of the electrochemical apparatus, reduce side reactions between the negative electrode and the electrolyte, and alleviate the float charging gas production performance and electrode thickness growth rate during cycling of the electrochemical apparatus.

In some embodiments, a compacted density of the negative electrode active material layer is pd g/mm², where 1.6≤pd≤1.8. For example, pd may be 1.6, 1.62, 1.63, 1.66, 1.67, 1.70, 1.73, 1.74, 1.78, 1.79, 1.8, or a value within a range defined by any two of these values. Adjusting the compacted density of the negative electrode active material layer to satisfy the above range helps to increase a volumetric energy density of the electrochemical apparatus and, in cooperation with the electrolyte system of this application, can further alleviate the float charging gas production performance and electrode thickness growth rate during cycling of the electrochemical apparatus.

On the basis of the above areal density and compacted density, the volumetric energy density of the electrochemical apparatus of this application is 830 Wh/L to 870 Wh/L, for example, it may be 830 Wh/L, 831 Wh/L, 837 Wh/L, 843 Wh/L, 844 Wh/L, 849 Wh/L, 855 Wh/L, 859 Wh/L, 861 Wh/L, 867 Wh/L, 870 Wh/L, or a value within a range defined by any two of these values. Adjusting the volumetric energy density of the electrochemical apparatus to satisfy the above range, in cooperation with the above electrolyte system, can alleviate the float charging gas production performance of the electrochemical apparatus and reduce the electrode thickness growth rate during cycling.

In this application, there is no particular limitation on the negative electrode plate, provided that the objectives of this application can be achieved. For example, the negative electrode plate includes a negative electrode current collector and a negative electrode active material layer disposed on at least one surface of the negative electrode current collector. In this application, the negative electrode active material layer may be disposed on one surface of the negative electrode current collector in a thickness direction or on both surfaces of the negative electrode current collector in the thickness direction. It should be noted that the “surface” herein may be an entire region of the negative electrode current collector or a partial region of the negative electrode current collector, which is not particularly limited in this application, provided that the objectives of this application can be achieved.

This application imposes no particular limitation on the negative electrode current collector, provided that the objectives of this application can be achieved. For example, the negative electrode current collector may include but is not limited to a copper foil, a copper alloy foil, a nickel foil, a stainless steel foil, a titanium foil, foamed nickel, foamed copper, or a composite current collector (for example, a carbon-copper composite current collector, a nickel-copper composite current collector, or a titanium-copper composite current collector). In this application, there is no particular limitation on the thicknesses of the negative electrode current collector and the negative electrode active material layer, provided that the objectives of this application can be achieved.

The negative electrode active material layer of this application includes a negative electrode active material. The negative electrode active material may include but is not limited to at least one of graphite, mesocarbon microbeads (MCMB), hard carbon, soft carbon, silicon, silicon-carbon composite, SiOₓ (0.5<x<1.6), Li—Sn alloy, Li—Sn—O alloy, Sn, SnO, SnO₂, spinel-structured lithium titanate-lithiated TiO₂—Li₄Ti₅O₁₂, Li—Al alloy, or metallic lithium.

The negative electrode active material layer in this application may further include a negative electrode binder and a negative electrode conductive agent, or the negative electrode active material layer may further include a negative electrode binder, a negative electrode conductive agent, and a thickener. This application imposes no particular limitation on the types of the negative electrode binder and the negative electrode conductive agent, provided that the objectives of this application can be achieved. For example, the negative electrode binder may include but is not limited to at least one of the above positive electrode binders, and the negative electrode conductive agent may include but is not limited to at least one of the above positive electrode conductive agents. This application imposes no particular limitation on the type of thickener, provided that the objectives of this application can be achieved. For example, the thickener may include but is not limited to at least one of sodium carboxymethyl cellulose or carboxymethyl cellulose. This application imposes no particular limitation on a mass ratio of the negative electrode active material, negative electrode conductive agent, negative electrode binder, and thickener in the negative electrode active material layer, and those skilled in the art may select according to actual needs, provided that the objectives of this application can be achieved.

This application imposes no particular limitation on the positive electrode, provided that the objectives of this application can be achieved. For example, the positive electrode includes a positive electrode current collector and a positive electrode active material layer located on at least one surface of the positive electrode current collector. The above “positive electrode active material layer located on at least one surface of the positive electrode current collector” means that the positive electrode active material layer may be located on one surface of the positive electrode current collector in a thickness direction or on both surfaces of the positive electrode current collector in the thickness direction. It should be noted that the “surface” herein may be an entire region of the surface of the positive electrode current collector or a partial region of the surface of the positive electrode current collector, which is not particularly limited in this application, provided that the objectives of this application can be achieved.

This application imposes no particular limitation on the positive electrode current collector, provided that the objectives of this application can be achieved. For example, the positive electrode current collector may include an aluminum foil, an aluminum alloy foil, or a composite current collector (for example, an aluminum-carbon composite current collector). The composite current collector may be formed by forming a metal material (copper, copper alloy, nickel, nickel alloy, titanium, titanium alloy, silver, silver alloy, or the like) on a polymer substrate.

The positive electrode active material layer of this application includes a positive electrode active material. This application imposes no particular limitation on the type of the positive electrode active material, provided that the objectives of this application can be achieved. For example, the positive electrode active material may include at least one of lithium nickel cobalt manganese oxide (LiNi_{0.90}Co_{0.05}Mn_{0.05}O₂ (NCM955), NCM811, NCM622, NCM523, or NCM111), lithium nickel cobalt aluminate, lithium iron phosphate, lithium vanadium phosphate, lithium cobalt phosphate, lithium manganese phosphate, lithium manganese iron phosphate, a lithium-rich manganese-based material, lithium cobalt oxide (LiCoO₂), lithium iron silicate, lithium vanadium silicate, lithium cobalt silicate, lithium manganese silicate, spinel-type lithium manganese oxide, spinel-type lithium nickel manganese oxide, or lithium titanate. In this application, the positive electrode active material may further include a non-metal element. For example, the non-metal element includes at least one of fluorine, phosphorus, boron, chlorine, silicon, or sulfur. In this application, there is no particular limitation on the thicknesses of the positive electrode current collector and positive electrode active material layer, provided that the objectives of this application can be achieved. For example, the thickness of the positive electrode current collector is 5 μm to 20 μm, and the thickness of the positive electrode active material layer applied on one surface is 30 μm to 120 μm.

In this application, the positive electrode active material layer may further include a positive electrode binder and a positive electrode conductive agent. This application imposes no particular limitation on the type of the positive electrode binder in the positive electrode active material layer, provided that the objectives of this application can be achieved. For example, the positive electrode binder may include but is not limited to at least one of polyvinylidene fluoride, polytetrafluoroethylene, polyolefins, sodium carboxymethyl cellulose, lithium carboxymethyl cellulose, modified polyvinylidene fluoride, modified styrene-butadiene rubber (SBR), or polyurethane. In some embodiments, the polyolefin binder includes at least one of polyethylene, polypropylene, polyester, polyenol, or polyacrylic acid.

This application imposes no particular limitation on the type of the positive electrode conductive agent in the positive electrode active material layer, provided that the objectives of this application can be achieved. In some embodiments, the positive electrode conductive agent includes: a carbon-based material, for example, natural graphite, artificial graphite, carbon black, acetylene black, Ketjen black, or carbon fiber; a metal-based material, for example, metal powder or metal fiber of copper, nickel, aluminum, or silver; a conductive polymer, for example, a polyphenylene derivative; or a mixture thereof. This application imposes no particular limitation on a mass ratio of the positive electrode active material, positive electrode conductive agent, and positive electrode binder in the positive electrode active material layer, and those skilled in the art may select according to actual needs, provided that the objectives of this application can be achieved. For example, a loading amount of the positive electrode active material in the positive electrode plate is 4.0 mg/cm² to 10.0 mg/cm².

There is no particular limitation on the electrochemical apparatus of this application. The electrochemical apparatus may include any apparatus where electrochemical reactions occur, for example, a secondary battery. The following takes a secondary battery as an example to illustrate this application in combination with some embodiments of this application. There is no particular limitation on the secondary battery of this application. For example, the secondary battery may include but is not limited to a lithium-ion secondary battery (also called a lithium-ion battery) or a sodium-ion secondary battery.

The secondary battery of this application further includes a separator. There is no particular limitation on the material and shape of the separator used in the secondary battery of this application, which may be any technology disclosed in the prior art. In some embodiments, the separator includes a polymer, an inorganic substance, or the like formed from a material stable to the electrolyte of this application.

For example, the separator may include a substrate layer and a surface treatment layer. The substrate layer is a non-woven fabric, film, or composite film having a porous structure. The material of the substrate layer is selected from at least one of polyethylene, polypropylene, polyethylene terephthalate, or polyimide. Specifically, a polypropylene porous film, a polyethylene porous film, a polypropylene non-woven fabric, a polyethylene non-woven fabric, or a polypropylene-polyethylene-polypropylene porous composite film may be used.

At least one surface of the substrate layer is provided with a surface treatment layer, where the surface treatment layer may be a polymer layer or an inorganic substance layer, or may be a layer formed by mixing a polymer and an inorganic substance. The inorganic substance layer includes inorganic particles and a binder. The inorganic particles are selected from at least one of aluminum oxide, silicon oxide, magnesium oxide, titanium oxide, hafnium dioxide, tin oxide, cerium dioxide, nickel oxide, zinc oxide, calcium oxide, zirconium oxide, yttrium oxide, silicon carbide, boehmite, aluminum hydroxide, magnesium hydroxide, calcium hydroxide, or barium sulfate. The binder is selected from at least one of polyvinylidene fluoride, vinylidene fluoride-hexafluoropropylene copolymer, polyamide, polyacrylonitrile, polyacrylate ester, polyacrylic acid, polyacrylate salt, polyvinylpyrrolidone, polyvinylether, polymethyl methacrylate, polytetrafluoroethylene, or polyhexafluoropropylene. The polymer layer contains a polymer. The material of the polymer is selected from at least one of polyamide, polyacrylonitrile, acrylate polymer, polyacrylic acid, polyacrylate salt, polyvinylpyrrolidone, polyvinylether, polyvinylidene fluoride, or poly(vinylidene fluoride-hexafluoropropylene).

The secondary battery of this application further includes a packaging bag for accommodating the positive electrode, the negative electrode, the separator, and electrolyte, as well as other components known in the field of secondary batteries, and this application imposes no limitation on the above other components. The packaging bag is not particularly limited in this application, which may be any packaging bag known in the art, provided that the objectives of this application can be achieved.

The preparation process of the secondary battery of this application is well known to those skilled in the art and is not particularly limited in this application. For example, it may include but is not limited to the following steps: stacking the positive electrode plate, the separator, and the negative electrode plate in sequence, and performing an operation such as winding or folding as needed to obtain an electrode assembly with a wound structure, placing the electrode assembly into the packaging bag, injecting the electrolyte into the packaging bag, and sealing to obtain the secondary battery; or stacking the positive electrode plate, the separator, and the negative electrode plate in sequence, then fixing four corners of an entire laminated structure with an adhesive tape to obtain an electrode assembly with a laminated structure, placing the electrode assembly into the packaging bag, injecting the electrolyte into the packaging bag, and sealing to obtain the secondary battery. In addition, an overcurrent prevention element, a guide plate, and the like may also be placed in the packaging bag as needed to prevent pressure rise, overcharge, and overdischarge inside the secondary battery.

According to a second aspect, this application provides an electronic apparatus including the above electrochemical apparatus.

The electronic apparatus of this application is not particularly limited, which may be any electronic apparatus known in the prior art. For example, the electronic apparatus may include but is not limited to a notebook computer, a pen-input computer, a mobile computer, an e-book player, a portable telephone, a portable fax machine, a portable copier, a portable printer, a stereo headset, a video recorder, a liquid crystal television, a portable cleaner, a portable CD player, a mini disc, a transceiver, an electronic notebook, a calculator, a memory card, a portable recorder, a radio, a backup power supply, a motor, an automobile, a motorcycle, a power-assisted bicycle, a bicycle, a lighting fixture, a toy, a game console, a clock, a power tool, a flash lamp, a camera, a large household battery, and a lithium-ion capacitor.

The following further illustrates the solutions of this application with reference to specific examples. Unless otherwise specified, the raw materials used in the following examples are all commercially available ordinary products, and the apparatuses or devices used are all purchased from conventional commercial channels. Various tests and evaluations are carried out according to the following methods. In addition, unless otherwise specified, “parts” and “%” are based on mass.

### Test for Float Charging Performance:

In an environment at 25 °C, the lithium-ion battery of each of the examples and comparative examples was left standing for 30 minutes. Then, the lithium-ion battery was charged at a constant current of 0.2 C to a battery voltage of 4.52 V, and a thickness of the lithium-ion battery was tested as h₀. Then, in an environment at 60 °C, float charging was performed with a small current not exceeding 100 mA to maintain the voltage of the lithium-ion battery at 4.52 V. During float charging, a thickness h₁ of the lithium-ion battery was tested every 100 h, and the time when the thickness h₁ of the lithium-ion battery was greater than or equal to 120% h₀ was recorded as the float charging gas production time.

### Test for Electrode Thickness Growth Rate:

The test temperature was 25 °C. The lithium-ion battery of each of examples and comparative examples was left standing for 30 minutes. After left standing, the lithium-ion battery was charged at a constant current of 0.2 C to a voltage of 4.52 V and then discharged at a constant current of 0.2 C to a voltage of 3.0 V. Subsequently, the discharged lithium-ion battery was disassembled, and an overall thickness of the negative electrode minus a thickness of the current collector was measured as a thickness do of the negative electrode before cycling.

Then, lithium-ion batteries of the same batch as the examples or comparative examples under test were each charged and discharged at a constant current of 1 C, where a charge cut-off voltage was 4.52 V, and a discharge cut-off voltage was 3.0 V. One charge-discharge process was used as one cycle. A total of 400 cycles of charge-discharge operations were performed. Finally, the lithium-ion battery after 400 cycles was charged at a constant current of 1 C. Then, the charged battery was disassembled. An overall thickness of the negative electrode minus a thickness of the current collector was measured as a thickness d₁ of the negative electrode after cycling. Electrode thickness growth rate=[(d₁−d₀)/d₀]×100%.

### Example 1-1

### <Preparation of Electrolyte>

In a dry argon atmosphere glove box, lithium hexafluorophosphate (LiPF₆) as a supporting electrolyte was dissolved in a solution including dimethyl carbonate, ethyl acetate, ethylene carbonate (EC), propylene carbonate (PC), diethyl carbonate (DEC), ethyl propionate (EP), and propyl propionate (PP). Based on a mass of the electrolyte, a mass percentage of lithium hexafluorophosphate was 12.5%; mass percentages of ethylene carbonate, propylene carbonate, diethyl carbonate, ethyl propionate, and propyl propionate were as shown in Table 1 below; the balance was dimethyl carbonate and ethyl acetate; and a mass ratio of dimethyl carbonate to ethyl acetate was 1:3.

### <Preparation of Negative Electrode Plate>

Artificial graphite as a negative electrode active material, Super P as a negative electrode conductive agent, sodium carboxymethyl cellulose (CMC—Na) as a thickener, and styrene-butadiene rubber (SBR) as a negative electrode binder were mixed at a mass ratio of 96.4:1.5:0.5:1.6, and then deionized water was added as a solvent to prepare a negative electrode slurry with a solid content of 30 wt %. The negative electrode slurry was uniformly applied on one surface of a copper foil as a negative electrode current collector with a thickness of 10 μm, and dried at 110 °C to obtain a negative electrode plate with one surface coated with a negative electrode active material layer. Then, the above steps were repeated on another surface of the negative electrode plate to obtain a negative electrode plate with both surfaces coated with negative electrode active material layers. A coating amount was adjusted, so that an areal density cw mg/mm² of the negative electrode active material layer satisfied Table 1. After coated, the negative electrode plate was cold-pressed and cut into a negative electrode plate with a specification of 76.6 mm×875 mm for later use.

### <Preparation of Positive Electrode Plate>

Lithium cobalt oxide (LiCoO₂) as a positive electrode active material, polyvinylidene fluoride (PVDF) as a positive electrode binder, and Super P as a positive electrode conductive agent were mixed at a mass ratio of 97:1.6:1.4, and then N-methylpyrrolidone (NMP) was added as a solvent to prepare a slurry with a solid content of 75 wt %, and the slurry was stirred well. The positive electrode slurry was uniformly applied on one surface of an aluminum foil as a positive electrode current collector with a thickness of 10 μm, and dried at 110 °C to obtain a positive electrode plate with one surface coated with a positive electrode active material. Then, the above steps were repeated on another surface of the positive electrode plate to obtain a positive electrode plate with both surfaces coated with positive electrode active materials. After coated, the positive electrode plate was cold-pressed and cut into a positive electrode plate with a specification of 74 mm×867 mm for later use.

### <Separator>

A polyethylene-polypropylene film with a thickness of 7 μm was used.

### <Preparation of Lithium-Ion Battery>

The positive electrode plate, separator, and negative electrode plate prepared above were stacked in sequence, so that the separator is located between the positive electrode plate and negative electrode plate for separation. Then, the resulting stack was wound to obtain an electrode assembly. After tab welding, the electrode assembly was placed into an aluminum-plastic film packaging shell and dried in a vacuum oven at 85 °C for 12 hours to remove moisture. Then, the electrolyte prepared above was injected. Processes such as vacuum sealing, standing, and formation were performed to obtain a lithium-ion battery.

### Examples 1-2 to 1-22 and Comparative Examples 1-1 to 1-6

These examples and comparative examples differed from Example 1-1 only in that the parameters shown were adjusted according to Table 1. The performance test results of examples and comparative examples were shown in Table 1.

TABLE 1

| | | | | | | | | | | Electrode |
|---|---|---|---|---|---|---|---|---|---|---|
| | | Mass per- | Mass per- | | Mass per- | Mass per- | Mass per- | | Float | thickness |
| | | centage A | centage B | | centage C | centage D | centage E | | charging | growth |
| | Areal | of ethylene | of propylene | | of diethyl | of ethyl | of propyl | | gas | rate during |
| | density cw | carbonate | carbonate | | carbonate | propionate | propionate | | production | cycling |
| No. | (mg/mm²) | (%) | (%) | A/B | (%) | (%) | (%) | (E + D)/C | time (D) | (%) |
| Example 1-1 | 8.44 | 10 | 10 | 1 | 7 | 4 | 10 | 2.00 | 69 | 9.1% |
| Example 1-2 | 8.44 | 10 | 10 | 1 | 7 | 4 | 12 | 2.29 | 70 | 9.1% |
| Example 1-3 | 8.44 | 10 | 10 | 1 | 7 | 21 | 28 | 7.00 | 74 | 9.1% |
| Example 1-4 | 8.44 | 10 | 10 | 1 | 7 | 21 | 35 | 8.00 | 80 | 9.2% |
| Example 1-5 | 8.44 | 15 | 10 | 1.50 | 7 | 21 | 12 | 4.71 | 81 | 9.3% |
| Example 1-6 | 8.44 | 16.5 | 10 | 1.65 | 7 | 21 | 12 | 4.71 | 77 | 9.5% |
| Example 1-7 | 8.44 | 18.5 | 10 | 1.85 | 7 | 21 | 12 | 4.71 | 76 | 9.2% |
| Example 1-8 | 8.44 | 30 | 10 | 3.00 | 7 | 21 | 12 | 4.71 | 70 | 8.8% |
| Example 1-9 | 8.44 | 16.5 | 12 | 1.38 | 7 | 21 | 12 | 4.71 | 69 | 8.7% |
| Example 1-10 | 8.44 | 16.5 | 14 | 1.18 | 7 | 21 | 12 | 4.71 | 67 | 8.5% |
| Example 1-11 | 8.44 | 16.5 | 15 | 1.10 | 7 | 21 | 12 | 4.71 | 62 | 8.2% |
| Example 1-12 | 8.44 | 16.5 | 12 | 1.38 | 7 | 30 | 12 | 6.00 | 60 | 8.1% |
| Example 1-13 | 8.44 | 16.5 | 12 | 1.38 | 7 | 31.5 | 12 | 6.21 | 71 | 8.8% |
| Example 1-14 | 8.44 | 16.5 | 12 | 1.38 | 7 | 37 | 12 | 7.00 | 73 | 8.8% |
| Example 1-15 | 8.44 | 16.5 | 12 | 1.38 | 7 | 40 | 12 | 7.43 | 75 | 9.1% |
| Example 1-16 | 8.44 | 16.5 | 12 | 1.38 | 10 | 31.5 | 12 | 4.35 | 73 | 8.9% |
| Example 1-17 | 8.44 | 16.5 | 12 | 1.38 | 11 | 31.5 | 12 | 3.95 | 75 | 8.9% |
| Example 1-18 | 8.44 | 16.5 | 12 | 1.38 | 13 | 31.5 | 12 | 3.35 | 79 | 9.0% |
| Example 1-19 | 8.44 | 16.5 | 12 | 1.38 | 15 | 31.5 | 12 | 2.90 | 74 | 9.2% |
| Example 1-20 | 9.27 | 16.5 | 12 | 1.38 | 11 | 31.5 | 12 | 3.95 | 76 | 8.9% |
| Example 1-21 | 9.91 | 16.5 | 12 | 1.38 | 11 | 31.5 | 12 | 3.95 | 78 | 8.8% |
| Example 1-22 | 10.38 | 16.5 | 12 | 1.38 | 11 | 31.5 | 12 | 3.95 | 80 | 8.6% |
| Comparative | 8.30 | 10 | 10 | 1 | 7 | 4 | 10 | 2.00 | 72 | 8.5% |
| Example 1-1 | | | | | | | | | | |
| Comparative | 10.50 | 10 | 10 | 1 | 7 | 4 | 10 | 2.00 | 78 | 8.8% |
| Example 1-2 | | | | | | | | | | |
| Comparative | 8.44 | 8 | 10 | 0.8 | 7 | 21 | 12 | 4.71 | 78 | 8.9% |
| Example 1-3 | | | | | | | | | | |
| Comparative | 8.44 | 33 | 10 | 3.3 | 7 | 21 | 12 | 4.71 | 78 | 9.2% |
| Example 1-4 | | | | | | | | | | |
| Comparative | 8.44 | 10 | 10 | 1 | 7 | 3 | 10 | 1.86 | 69 | 9.1% |
| Example 1-5 | | | | | | | | | | |
| Comparative | 8.44 | 10 | 10 | 1 | 7 | 30 | 28 | 8.29 | 71 | 9.4% |
| Example 1-6 | | | | | | | | | | |

It can be seen from Table 1 that in this application, the mass percentages of the components in the electrolyte are adjusted, where the mass percentage A % of ethylene carbonate and the mass percentage B % of propylene carbonate satisfy: 1≤A/B≤3; and the mass percentage C % of diethyl carbonate, the mass percentage D % of ethyl propionate, and the mass percentage E % of propyl propionate satisfy: 2≤(E+D)/C≤8. The components closely cooperate to alleviate the float charging gas production performance and negative electrode thickness growth during cycling of the lithium-ion battery with a high negative electrode areal density, exhibiting excellent comprehensive performance. In particular, when the mass percentages of the components are adjusted to satisfy 15≤A≤30, 10≤B≤15, 10≤C≤15, 30≤D≤40, and/or 10≤E≤35, better cooperation among the components can be facilitated, further alleviating the float charging gas production performance and negative electrode thickness growth during cycling of the lithium-ion battery.

In particular, when the mass percentages of ethylene carbonate and propylene carbonate are adjusted to satisfy 1.5≤A/B≤1.85, the float charging gas production performance and negative electrode thickness growth during cycling of lithium-ion battery can be further alleviated. When diethyl carbonate, ethyl propionate, and propyl propionate are adjusted to satisfy 2.3≤(E+D)/C≤7.0, the float charging gas production performance and negative electrode thickness growth during cycling of the lithium-ion battery can be further alleviated.

### Examples 2-1 to 2-24

These examples differed from Example 1-9 only in that the parameters shown for the electrolytes were adjusted according to Table 2. In the preparation processes of the electrolytes of Examples 2-1 to 2-24, the corresponding mass percentages of substances were also dissolved in a solution including dimethyl carbonate, ethyl acetate, ethylene carbonate (EC), propylene carbonate (PC), diethyl carbonate (DEC), ethyl propionate (EP), and propyl propionate (PP). The performance test results of the examples were shown in Table 2.

TABLE 2

| | | | | | | | | | | Electrode |
|---|---|---|---|---|---|---|---|---|---|---|
| | Mass per- | Mass per- | Mass per- | | | | | | | thickness |
| | centage | centage | centage H | | | Mass per- | | Mass per- | Float | growth |
| | F of | G of | of 1,3,6- | | Mass per- | centage V | | centage P | charging | rate |
| | succino- | adipo- | hexanetri- | | centage U | of 1,3- | Second | of second | gas | during |
| | nitrile | nitrile | carbo- | | of FEC | propane | lithium | lithium | production | cycling |
| No. | (%) | (%) | nitrile (%) | G/(F + H) | (%) | sultone (%) | salt type | salt (%) | time (D) | (%) |
| Example 2-1 | 0.8 | 2.8 | 2 | 1 | \ | \ | \ | \ | 73 | 8.9% |
| Example 2-2 | 0.8 | 3.3 | 2.2 | 1.1 | \ | \ | \ | \ | 76 | 8.9% |
| Example 2-3 | 0.8 | 4.2 | 2.7 | 1.2 | \ | \ | \ | \ | 80 | 9.0% |
| Example 2-4 | 0.8 | 4.94 | 3 | 1.3 | \ | \ | \ | \ | 81 | 9.3% |
| Example 2-5 | 1 | 3.52 | 2.2 | 1.1 | \ | \ | \ | \ | 77 | 8.9% |
| Example 2-6 | 2.3 | 4.95 | 2.2 | 1.1 | \ | \ | \ | \ | 79 | 8.9% |
| Example 2-7 | 2.7 | 5.39 | 2.2 | 1.1 | \ | \ | \ | \ | 82 | 9.0% |
| Example 2-8 | 3 | 5.72 | 2.2 | 1.1 | \ | \ | \ | \ | 83 | 9.2% |
| Example 2-9 | 2.3 | 4.95 | 2.2 | 1.1 | 4 | \ | \ | \ | 76 | 8.8% |
| Example 2-10 | 2.3 | 4.95 | 2.2 | 1.1 | 6 | \ | \ | \ | 74 | 8.6% |
| Example 2-11 | 2.3 | 4.95 | 2.2 | 1.1 | 8 | \ | \ | \ | 73 | 8.4% |
| Example 2-12 | 2.3 | 4.95 | 2.2 | 1.1 | 9.55 | \ | \ | \ | 65 | 8.5% |
| Example 2-13 | 2.3 | 4.95 | 2.2 | 1.1 | \ | 2 | \ | \ | 81 | 9.0% |
| Example 2-14 | 2.3 | 4.95 | 2.2 | 1.1 | \ | 3 | \ | \ | 83 | 9.0% |
| Example 2-15 | 2.3 | 4.95 | 2.2 | 1.1 | \ | 4 | \ | \ | 86 | 9.1% |
| Example 2-16 | 2.3 | 4.95 | 2.2 | 1.1 | \ | 6 | \ | \ | 80 | 9.2% |
| Example 2-17 | 2.3 | 4.95 | 2.2 | 1.1 | \ | 3 | Lithium | 0.1 | 83 | 8.9% |
| | | | | | | | tetrafluoro- | | | |
| | | | | | | | borate | | | |
| Example 2-18 | 2.3 | 4.95 | 2.2 | 1.1 | \ | 3 | Lithium | 0.2 | 84 | 8.8% |
| | | | | | | | tetrafluoro- | | | |
| | | | | | | | borate | | | |
| Example 2-19 | 2.3 | 4.95 | 2.2 | 1.1 | \ | 3 | Lithium | 0.4 | 86 | 8.6% |
| | | | | | | | tetrafluoro- | | | |
| | | | | | | | borate | | | |
| Example 2-20 | 2.3 | 4.95 | 2.2 | 1.1 | \ | 3 | Lithium | 0.8 | 85 | 8.8% |
| | | | | | | | tetrafluoro- | | | |
| | | | | | | | borate | | | |
| Example 2-21 | 2.3 | 4.95 | 2.2 | 1.1 | \ | 3 | Lithium | 0.1 | 83 | 8.8% |
| | | | | | | | difluoro(oxalato) | | | |
| | | | | | | | borate | | | |
| Example 2-22 | 2.3 | 4.95 | 2.2 | 1.1 | \ | 3 | Lithium | 0.2 | 85 | 8.6% |
| | | | | | | | difluoro(oxalato) | | | |
| | | | | | | | borate | | | |
| Example 2-23 | 2.3 | 4.95 | 2.2 | 1.1 | \ | 3 | Lithium | 0.4 | 87 | 8.5% |
| | | | | | | | difluoro(oxalato) | | | |
| | | | | | | | borate | | | |
| Example 2-24 | 2.3 | 4.95 | 2.2 | 1.1 | \ | 3 | Lithium | 0.8 | 82 | 8.8% |
| | | | | | | | difluoro(oxalato) | | | |
| | | | | | | | borate | | | |

It can be seen from Table 2 that when succinonitrile, adiponitrile, and 1,3,6-hexanetricarbonitrile are further added to the electrolyte and their mass percentages in the electrolyte are adjusted to satisfy 2≤H≤3 and 1≤G/(F+H)≤1.3, the float charging gas production performance of the lithium-ion battery can be further alleviated. In particular, when the mass percentage of succinonitrile satisfies 1≤F≤3, the float charging gas production performance of the lithium-ion battery can be further alleviated.

In particular, when fluoroethylene carbonate is further added to the electrolyte and its mass percentage is adjusted to satisfy 4≤U≤9.55, the electrode thickness growth rate during cycling can be further alleviated. More preferably, when 6≤U≤8, the electrode thickness growth rate during cycling can be further reduced.

In particular, when 1,3-propane sultone is further added to the electrolyte and its mass percentage is adjusted to satisfy 2≤V≤6, the float charging gas production performance of the lithium-ion battery can be further alleviated. In particular, when 3≤V≤4, the float charging gas production performance of the lithium-ion battery can be further alleviated.

In particular, when the second lithium salt shown in Table 2 is further added to the electrolyte and the mass percentage P % of the second lithium salt is adjusted to satisfy 0.1≤P≤0.8, the float charging gas production performance and electrode thickness growth rate during cycling of the lithium-ion battery can be further alleviated. Preferably, when 0.2≤P≤0.4, the float charging gas production performance and electrode thickness growth rate during cycling of the lithium-ion battery can be more significantly alleviated.

### Examples 3-1 to 3-10

These examples differed from Example 2-15 only in that the parameters shown for the electrolytes were adjusted according to Table 3. In the preparation processes of the electrolytes of Examples 3-1 to 3-10, the corresponding mass percentages of substances were also dissolved in a solution including dimethyl carbonate, ethyl acetate, ethylene carbonate (EC), propylene carbonate (PC), diethyl carbonate (DEC), ethyl propionate (EP), and propyl propionate (PP). The performance test results of the examples were shown in Table 3.

TABLE 3

| | | Mass | | | Electrode |
|---|---|---|---|---|---|
| | Mass percentage | percentage Y | | | thickness |
| | X of | of tris(4- | Mass percentage | Float | growth |
| | tetrakis(trimethyl- | morpholinyl) | of diethyl | charging gas | rate during |
| | siloxy)titanium | phosphine | phenylphosphonate | production | cycling |
| No. | (%) | oxide (%) | (%) | time (h) | (%) |
| Example 3-1 | 1 | \ | \ | 88 | 8.9% |
| Example 3-2 | 1.4 | \ | \ | 90 | 8.6% |
| Example 3-3 | 2 | \ | \ | 89 | 8.7% |
| Example 3-4 | \ | 0.3 | \ | 88 | 9.0% |
| Example 3-5 | \ | 0.5 | \ | 92 | 8.9% |
| Example 3-6 | \ | 0.6 | \ | 89 | 9.0% |
| Example 3-7 | \ | \ | 0.3 | 89 | 9.0% |
| Example 3-8 | \ | \ | 0.4 | 92 | 8.8% |
| Example 3-9 | \ | \ | 0.6 | 90 | 8.9% |
| Example 3-10 | 1.4 | 0.5 | 0.4 | 95 | 8.3% |

It can be seen from Table that further adding tetrakis(trimethylsiloxy)titanium to the electrolyte and adjusting its mass percentage to satisfy 1≤X≤2 can further reduce the electrode thickness growth rate during cycling of the lithium-ion battery. Further adding tris(4-morpholinyl)phosphine oxide or diethyl phenylphosphonate to the electrolyte and adjusting their respective mass percentages to satisfy 0.3≤Y≤0.5 and 0.3≤Z≤0.5 can further alleviate the float charging gas production performance of the lithium-ion battery. In particular, when the electrolyte simultaneously includes the above three substances, interaction among the components can more significantly alleviate the float charging gas production performance and electrode thickness growth rate during cycling of the lithium-ion battery.

The above are merely preferred embodiments of this application and are not intended to limit this application. Any modifications, equivalent replacements, and improvements made within the principles of this application shall be included in the protection scope of this application.

What is claimed is:

1. An electrochemical apparatus, comprising a positive electrode, a negative electrode, and an electrolyte; wherein the negative electrode comprises a negative electrode current collector and a negative electrode active material layer located on at least a part of a surface of the negative electrode current collector; and an areal density of the negative electrode active material layer is cw mg/mm², wherein 8.44≤cw≤10.38; and
the electrolyte comprises ethylene carbonate, propylene carbonate, diethyl carbonate, ethyl propionate and propyl propionate; based on a mass of the electrolyte, a mass percentage of ethylene carbonate is A %, a mass percentage of propylene carbonate is B %, a mass percentage of diethyl carbonate is C %, a mass percentage of ethyl propionate is D %, and a mass percentage of propyl propionate is E %, wherein
1≤A/B≤3, and 2≤(E+D)/C≤8.

2. The electrochemical apparatus according to claim 1, wherein the electrolyte satisfies at least one of the following conditions:
(1) 15≤A≤30;
(2) 10≤B≤15;
(3) 10≤C≤15;
(4) 30≤D≤40;
(5) 10≤E≤35;
(6) 1.5≤A/B≤2; or
(7) 4≤(E+D)/C≤5.

3. The electrochemical apparatus according to claim 1, wherein the electrolyte further comprises succinonitrile, adiponitrile, and 1,3,6-hexanetricarbonitrile; and
based on the mass of the electrolyte, a mass percentage of succinonitrile is F %, a mass percentage of adiponitrile is G %, and a mass percentage of 1,3,6-hexanetricarbonitrile is H %, wherein 2≤H≤3, and 1≤G/(F+H)≤1.3.

4. The electrochemical apparatus according to claim 2, wherein the electrolyte further comprises succinonitrile, adiponitrile, and 1,3,6-hexanetricarbonitrile; and
based on the mass of the electrolyte, a mass percentage of succinonitrile is F %, a mass percentage of adiponitrile is G %, and a mass percentage of 1,3,6-hexanetricarbonitrile is H %, wherein 2≤H≤3, and 1≤G/(F+H)≤1.3.

5. The electrochemical apparatus according to claim 3, wherein 1≤F≤3.

6. The electrochemical apparatus according to claim 3, wherein the electrolyte further comprises fluoroethylene carbonate and 1,3-propane sultone; and based on the mass of the electrolyte, a mass percentage of fluoroethylene carbonate is U %, and a mass percentage of 1,3-propane sultone is V %, wherein 4≤U≤9.55, and 2≤V≤6.

7. The electrochemical apparatus according to claim 4, wherein the electrolyte further comprises fluoroethylene carbonate and 1,3-propane sultone; and based on the mass of the electrolyte, a mass percentage of fluoroethylene carbonate is U %, and a mass percentage of 1,3-propane sultone is V %, wherein 4≤U≤9.55, and 2≤V≤6.

8. The electrochemical apparatus according to claim 6, wherein 6≤U≤8; or 3≤V≤4.

9. The electrochemical apparatus according to claim 5, wherein the electrolyte further comprises lithium hexafluorophosphate and a second lithium salt, the second lithium salt comprising lithium tetrafluoroborate or lithium difluoro(oxalato)borate; and
based on the mass of the electrolyte, a mass percentage of the second lithium salt is P %, wherein 0.1≤P≤0.8, preferably 0.2≤P≤0.4.

10. The electrochemical apparatus according to claim 6, wherein the electrolyte further comprises lithium hexafluorophosphate and a second lithium salt, the second lithium salt comprising lithium tetrafluoroborate or lithium difluoro(oxalato)borate; and
based on the mass of the electrolyte, a mass percentage of the second lithium salt is P %, wherein 0.1≤P≤0.8, preferably 0.2≤P≤0.4.

11. The electrochemical apparatus according to claim 8, wherein the electrolyte further comprises lithium hexafluorophosphate and a second lithium salt, the second lithium salt comprising lithium tetrafluoroborate or lithium difluoro(oxalato)borate; and
based on the mass of the electrolyte, a mass percentage of the second lithium salt is P %, wherein 0.1≤P≤0.8, preferably 0.2≤P≤0.4.

12. The electrochemical apparatus according to claim 5, wherein the electrolyte satisfies at least one of the following conditions:
(1) the electrolyte further comprises tetrakis(trimethylsiloxy) titanium; and based on the mass of the electrolyte, a mass percentage of tetrakis(trimethylsiloxy) titanium is X %, wherein 1≤X≤2;
(2) the electrolyte further comprises tris(4-morpholinyl)phosphine oxide; and based on the mass of the electrolyte, a mass percentage of tris(4-morpholinyl)phosphine oxide is Y %, wherein 0.3≤Y≤0.5; or
(3) the electrolyte further comprises diethyl phenylphosphonate; and based on the mass of the electrolyte, a mass percentage of diethyl phenylphosphonate is Z %, wherein 0.3≤Z≤0.5.

13. The electrochemical apparatus according to claim 6, wherein the electrolyte satisfies at least one of the following conditions:
(1) the electrolyte further comprises tetrakis(trimethylsiloxy) titanium; and based on the mass of the electrolyte, a mass percentage of tetrakis(trimethylsiloxy) titanium is X %, wherein 1≤X≤2;
(2) the electrolyte further comprises tris(4-morpholinyl)phosphine oxide; and based on the mass of the electrolyte, a mass percentage of tris(4-morpholinyl)phosphine oxide is Y %, wherein 0.3≤Y≤0.5; or
(3) the electrolyte further comprises diethyl phenylphosphonate; and based on the mass of the electrolyte, a mass percentage of diethyl phenylphosphonate is Z %, wherein 0.3≤Z≤0.5.

14. The electrochemical apparatus according to claim 8, wherein the electrolyte satisfies at least one of the following conditions:
(1) the electrolyte further comprises tetrakis(trimethylsiloxy) titanium; and based on the mass of the electrolyte, a mass percentage of tetrakis(trimethylsiloxy) titanium is X %, wherein 1≤X≤2;
(2) the electrolyte further comprises tris(4-morpholinyl)phosphine oxide; and based on the mass of the electrolyte, a mass percentage of tris(4-morpholinyl)phosphine oxide is Y %, wherein 0.3≤Y≤0.5; or
(3) the electrolyte further comprises diethyl phenylphosphonate; and based on the mass of the electrolyte, a mass percentage of diethyl phenylphosphonate is Z %, wherein 0.3≤Z≤0.5.

15. The electrochemical apparatus according to claim 1, wherein the negative electrode active material layer comprises graphite, the graphite comprising natural graphite and/or artificial graphite, wherein an average particle size of the graphite is 7 μm to 14 μm; and/or
a compacted density of the negative electrode active material layer is pd g/mm², wherein 1.6≤pd≤1.8.

16. An electronic apparatus, comprising an electrochemical apparatus; the electrochemical apparatus comprises a positive electrode, a negative electrode, and an electrolyte; wherein the negative electrode comprises a negative electrode current collector and a negative electrode active material layer located on at least a part of a surface of the negative electrode current collector; and an areal density of the negative electrode active material layer is cw mg/mm², wherein 8.44≤cw≤10.38; and
the electrolyte comprises ethylene carbonate, propylene carbonate, diethyl carbonate, ethyl propionate and propyl propionate; based on a mass of the electrolyte, a mass percentage of ethylene carbonate is A %, a mass percentage of propylene carbonate is B %, a mass percentage of diethyl carbonate is C %, a mass percentage of ethyl propionate is D %, and a mass percentage of propyl propionate is E %, wherein
1≤A/B≤3, and 2≤(E+D)/C≤8.

17. The electronic apparatus according to claim 16, wherein the electrolyte satisfies at least one of the following conditions:
(1) 15≤A≤30;
(2) 10≤B≤15;
(3) 10≤C≤15;
(4) 30≤D≤40;
(5) 10≤E≤35;
(6) 1.5≤A/B≤2; or
(7) 4≤(E+D)/C≤5.

18. The electronic apparatus according to claim 16, wherein the electrolyte further comprises succinonitrile, adiponitrile, and 1,3,6-hexanetricarbonitrile; and
based on the mass of the electrolyte, a mass percentage of succinonitrile is F %, a mass percentage of adiponitrile is G %, and a mass percentage of 1,3,6-hexanetricarbonitrile is H %, wherein 2≤H≤3, and 1≤G/(F+H)≤1.3.

19. The electronic apparatus according to claim 18, wherein 1≤F≤3.

20. The electronic apparatus according to claim 18, wherein the electrolyte further comprises fluoroethylene carbonate and 1,3-propane sultone; and based on the mass of the electrolyte, a mass percentage of fluoroethylene carbonate is U %, and a mass percentage of 1,3-propane sultone is V %, wherein 4≤U≤9.55, and 2≤V≤6.
